(19) United States
(12) Patent Application Publication
(10) Pub. No.: US 2018/0235164 A1
(43) Pub. Date: Aug. 23, 2018

(54) HYDROPONIC SYSTEM AND METHOD USING THE SAME

(71) Applicant: Advanced Agritech Co., Limited, Taipei City (TW)

(72) Inventor: Yeh-Chang CHOU, Taipei City (TW)

(21) Appl. No.: 15/614,635

(22) Filed: Jun. 6, 2017

(30) Foreign Application Priority Data
Feb. 17, 2017 (TW) 106105346

(51) Int. Cl. A01G 31/02; A01G 31/04

(52) U.S. Cl. CPC A01G 31/02; A01G 31/00; A01G 31/04

(57) ABSTRACT

A hydroponic system includes a container having a first side and a second side opposite to the first side; a cultivating medium filling in the container; and a plurality of cultivating boards disposed in the container, in which the cultivating boards includes a plurality of hydroponic plants cultivated thereon, in which the hydroponic plants of each of the cultivating boards correspond to one of a plurality of cultivating stages of the hydroponic plants; and the cultivating boards are sequentially arranged from the first side toward the second side, and sequentially arranged along the cultivating stages of the hydroponic plants.

### PRIORITY CLAIM AND CROSS-REFERENCE

This application claims priority to Taiwan Application Serial Number 106105346, filed Feb. 17, 2017, which is herein incorporated by reference.

### BACKGROUND

In recent years, the process of the technology development, climate change, environmental pollution, and the urbanization has increasingly influenced the agricultural development. For example, the area of safe and arable lands has decreased rapidly. As a result, hydroponic cultivation with vertical planting has drawn more and more attention. It consumes less power, water, and space, but also provides more than ten times yield than conventional planar cultivation. It provides an advantageous method for stable staple-food supply, and governments continuously promote such technological agricultural methods.

Depending on different equipment, lighting condition, cultivation method, and harvest method, even the same variety of seeds may have various product quality and yield. Equipment and method are the two important developments of the hydroponic cultivation. This is because conventional equipment generates light waste and time waste, such that the product quality and yield are unstable.

As a result, for benefitting the harvest property, the present disclosure provides a method for hydroponic cultivation. The method is convenient, easy-to-use, and provides good planting condition to the hydroponic plants, such that the product may have better quality and yield.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1A and 1B are perspective view and cross-sectional view of a hydroponic system in accordance with some embodiments, respectively.

FIG. 2 is a schematic view for operating a hydroponic system in accordance with some embodiments.

FIG. 3 is a schematic view for operating a hydroponic system in accordance with some embodiments.

FIGS. 4 and 5 are perspective views of hydroponic systems in accordance with some embodiments, respectively.

FIGS. 6 to 8 are cross-sectional views of hydroponic systems in accordance with some embodiments, respectively.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

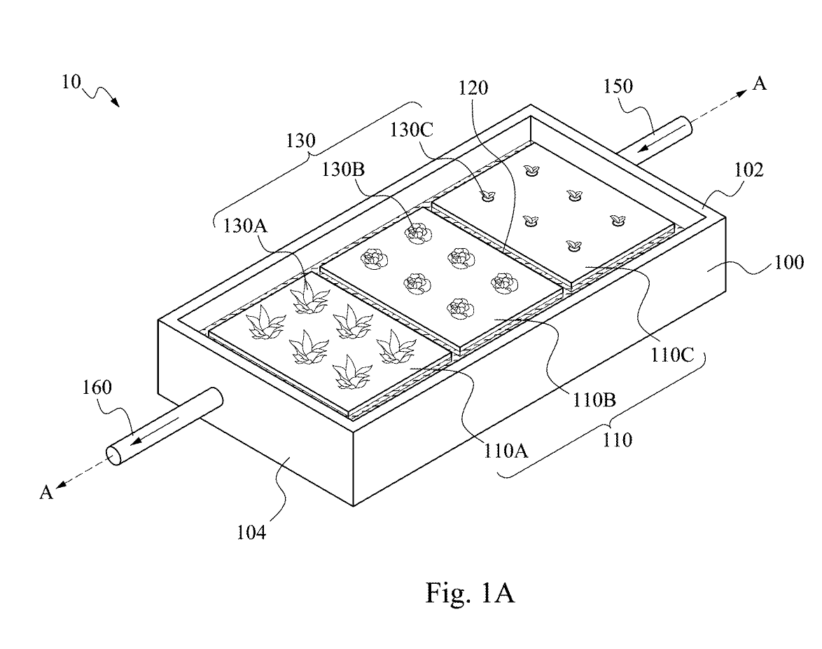

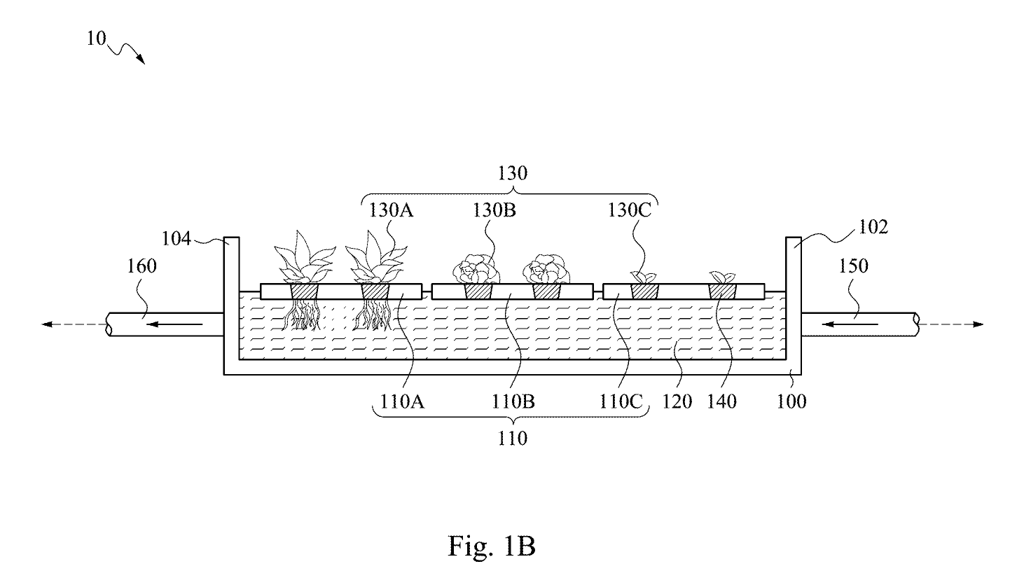

FIGS. 1A and 1B are perspective view and cross-sectional view of a hydroponic system in accordance with some embodiments, respectively. FIG. 1B is cross-sectional view cut along line A-A of FIG. 1A. The hydroponic system 10 includes a container 100, a plurality of cultivating boards 110, and a cultivating medium 120. The container 100 has a first side 102 and a second side 104 opposite to the first side 102. The cultivating medium 120 is filled in the container 100. The cultivating boards 110 are placed on the cultivating medium 120, in which the density of the cultivating boards 110 is smaller than that of the cultivating medium 120, such that the cultivating boards 110 float on the cultivating medium 120. In some embodiments, the cultivating boards 110 may be made from Styrofoam, or other suitable material.

In the present embodiment, there are three cultivating boards 110A, 110B, and 110C. Each of the cultivating boards 110A, 110B, and 110C has a plurality of hydroponic plants 130. In some embodiments, the hydroponic plants 130 may be vegetables, or other suitable plants. In detail, the cultivating board 110A has hydroponic plants 130A cultivated thereon, the cultivating board 110B has hydroponic plants 130B cultivated thereon, and the cultivating board 110C has hydroponic plants 130C cultivated thereon, respectively. The hydroponic plants 130A, 130B, and 130C have same variety, but correspond to different cultivating time and cultivating condition. In the present embodiment, the cultivating period is three days, which respectively correspond to the hydroponic plants 130A, 130B, and 130C. For example, the hydroponic plants 130A are in maturation phase and about to harvest, the hydroponic plants 130C are in seedling phase, and the growing condition of the hydroponic plants 130B is present between that of the hydroponic plants 130A and 130C.

According to the above descriptions, the hydroponic plants 130A are cultivated longer than the hydroponic plants 130B in the container 100. That is, the hydroponic plants 130A are disposed in the container 100 earlier than the hydroponic plants 130B. Similarly, the hydroponic plants 130B are cultivated longer than the hydroponic plants 130C in the container 100. As a result, the cultivating boards 110A to 110C are arranged sequentially. Generally, the cultivating board 110A is close to the second side 104 of the container 100, and the cultivating board 110A is close to the first side 102 of the container 100, respectively.

The cultivating boards 110 further include an absorbent 140 for absorbing cultivating medium 120 to provide hydroponic plants 130 nutrients. Further, the absorbent 140 can support the roots of the hydroponic plants 130. In some embodiments, the absorbent 140 may include wood fiber, sponge, mineral wool, or other suitable materials.

In the present embodiments, each of the cultivating boards 110 includes six hydroponic plants 130 cultivated thereon, but the present disclosure does not limit thereto. It is noted that the number of the hydroponic plants 130 and the cultivating boards 110, and the cultivating period of the hydroponic plants 130 are merely used to explain, and are not used to limit the present disclosure.

The hydroponic system 10 further includes a supply pipe 150 and a drain pipe 160 disposed on opposite side of the container 100. In greater detail, the supply pipe 150 is disposed on the first side 102 of the container 100, and the drain pipe 160 is disposed on the second side 104 of the container 100. The supply pipe 150 supplies cultivating medium 120 into the container 100, and the drain pipe 160 drains the cultivating medium 120 from the container 100. In some embodiments, the cultivating medium 120 may be recycling. The supply pipe 150 and the drain pipe 160 may be connected to an external circulation system to cyclically provide cultivating medium 120 into the container 100.

The cultivating medium 120 flows from the supply pipe 150 toward the drain pipe 160. In the present embodiment, the cultivating medium 120 flows through the cultivating boards 110C, 110B, and 110A. As a result, the direction from supply pipe 150 toward the drain pipe 160 (the direction from the first side 102 toward the second side 104) is consistent with the arrangement direction of the cultivating boards 110, and is consistent with the cultivating period of the hydroponic plants 130.

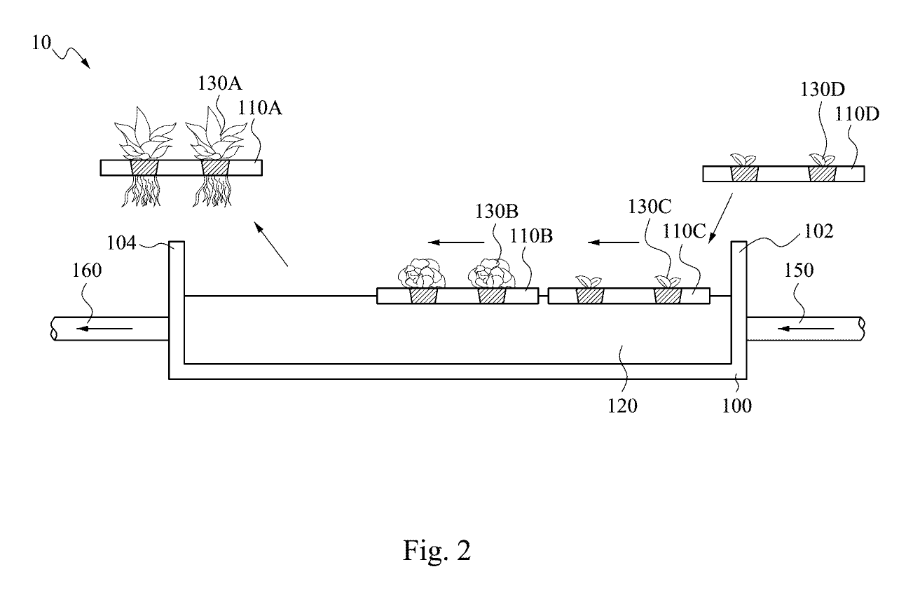

FIG. 2 is a schematic view for operating a hydroponic system in accordance with some embodiments. Descriptions similar to that of FIGS. 1A and 1B in configuration and some details are not repeated here to avoid duplicity. As mentioned before, since the hydroponic plants 130A are in maturation phase and about to harvest, the hydroponic plants 130A may be taken out together with the cultivating board 110A from the second side 104 of the container 100. After the cultivating board 110A is taken out, the space left by the cultivating board 110A may be filled by pushing the cultivating boards 110C and 110C with the hydroponic plants 130B and 130C toward the space. In the present embodiment, since the cultivating boards 110 float on the cultivating medium 120, users can push the cultivating board 110C, driving the cultivating board 110B together, toward the second side 104 of the container 100. After the cultivating boards 110B and 110C are moved forward, a prepared cultivating board 110D and hydroponic plants 130D cultivated thereon may be disposed into the container 100 from the first side 102 of the container 100 to start a new cultivating cycle. In the present disclosure, since the cultivating boards 110 float on the cultivating medium 120, the users may push only one cultivating board 110 (e.g. the cultivating board 110C described above), and drive all cultivating boards 110 forward at the same time. In some other embodiments, due to different variety of the hydroponic plants 130, the container 100 may include lots of the cultivating boards 110 (e.g. 10 or more). Such method may increase the efficiency of moving the cultivating board and further reduce labor.

The cultivating boards 110B and 110C may be moved by hand, and may also be moved by automation equipment. Alternatively, as mentioned before, since the cultivating medium 120 flows from the supply pipe 150 toward the drain pipe 160, the cultivating boards 110B and 110C may automatically flow forward along the water flow after taking out the cultivating board 110A in some other embodiments, thereby reducing labor and time.

The present disclosure includes various advantages. For example, by periodically moving the cultivating boards, the hydroponic plants may complete a cultivating period in one container without transplantation. Such method may reduce damage from transplantation, and may also reduce labor and time. Further, the present disclosure with cultivating board floating on cultivating medium provides not only an easy and convenient operation method, but also reduces weight and cost.

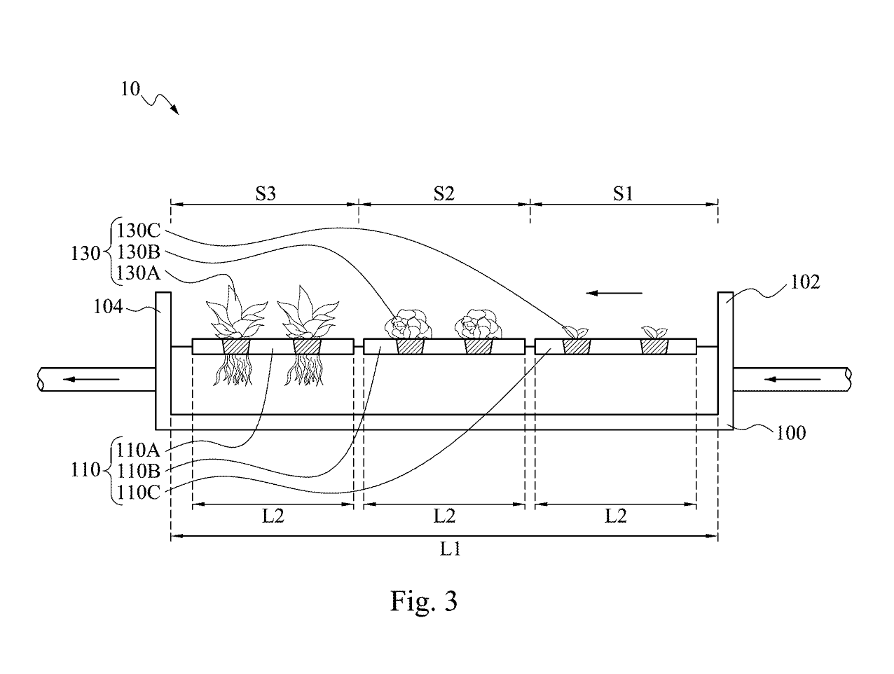

FIG. 3 is a schematic view for operating a hydroponic system in accordance with some embodiments. FIG. 3 is a detail description of FIG. 2. In some embodiments, the number of the cultivating boards 110 is the same as a number of the cultivating stages of the cultivating period of the hydroponic plants 130. For example, the cultivating period of the hydroponic plants 130 is three days, and the number of the cultivating boards 110 is three (e.g. the cultivating boards 110A, 110B, and 110C), accordingly. The cultivating boards 110A, 110B, and 110C include hydroponic plants 130A, 130B, and 130C cultivated thereon, respectively. The container 100 may be divided into cultivating stages S1, S2, and S3. In the present embodiment, the first day of the cultivating period of the hydroponic plants 130 corresponds to cultivating stage S1, the second day corresponds to cultivating stage S2, and third day corresponds to cultivating stage S3, respectively. In other words, cultivating stages S1 to S3 correspond to the growing process (e.g. from seedling to maturation) of the hydroponic plants 130.

The following description discusses the operation principle of the hydroponic system 10, and with cultivating boards 110 and hydroponic plants 130 for example. First, a cultivating board 110C with the hydroponic plants 130C is disposed into the container 100 and floating on the cultivating medium 120. It is noted that the position of the cultivating board 110C corresponds to the cultivating stage S1, and the cultivating stage S1 represents the seedling phase of the hydroponic plants.

Then, the cultivating board 110C, with the hydroponic plants 130C, is sequentially moved to the following stages according to the cultivating period. In the present embodiment, the cultivating period of the hydroponic plants 130C is three days. Thus, in the first day, the position of the cultivating board 110C corresponds to the cultivating stage S1. As moving toward the next stage of the cultivating period (e.g. the second day), the cultivating board 110C, with the hydroponic plants 130C, is moved to the position of the next cultivating stage (e.g. the cultivating stage S2). Accordingly, in the third day, the cultivating board 110C, with the hydroponic plants 130C, is moved from the position of the cultivating stage S2 to the position of the cultivating stage S3.

It is noted that each of the hydroponic plants 130 is moved, together with the cultivating board 110, from the cultivating stage S1 toward the cultivating stage S3, sequentially. From other perspectives, in FIG. 3, the hydroponic plants 130A have experienced the cultivating stages S1 to S3, the hydroponic plants 130B have experienced the cultivating stages S1 to S2, and the hydroponic plants 130C are still in cultivating stage S1. Thus, the hydroponic plants 130A and the cultivating board 110A stay longer than the hydroponic plants 130C and the cultivating board 110C in the container 100. That is, the cultivating board 110A to 110C and the corresponding hydroponic plants 130A to 130C are arranged along the cultivating period (or cultivating stages) of the hydroponic plants 130.

The container 100 has a length L1. The cultivating boards 110 have a length L2, and the cultivating boards 110 have substantially the same length. The term “substantially” as used herein may be applied to modify any quantitative representation which could permissibly vary without resulting in a change in the basic function to which it is related. In some embodiments, the length L1 of the container 100, the length L2 of the cultivating boards 110, and the number of the cultivating stages of the hydroponic plants 130 have a relationship:

L2≤L1/P (1)

P represents the number of the cultivating stages of the hydroponic plants 130. From other perspectives, the number of the cultivating stages of the hydroponic plants is identical to the number of the cultivating boards. In FIG. 3, the length L2 is slightly smaller than the quotient of the length L1 divided by P (the number of the cultivating stages), such that the cultivating boards 110 may include a gap therebetween to prevent stuck.

In practice, if the length of the container is constant, the length of the cultivating boards may be modified according to different cultivating stages. In some embodiments, since the cultivating boards may be made from Styrofoam, which is easy to cut, the length of the cultivating boards may be modified easily. Alternatively, the cultivating boards may have constant length, so users can manufacture a smaller or larger container according to different hydroponic plants to stabilize the product yield.

In some other embodiments, the number of the cultivating boards is not equal to the cultivating stages of the hydroponic plants. For example, the number of the cultivating boards may be equal to half of the cultivating stages, and the hydroponic plants may be cultivated in a first container and a second container to complete a full cultivating period. The hydroponic plants may be cultivated in the first container for a half period, and may be moved to the second container for another half period.

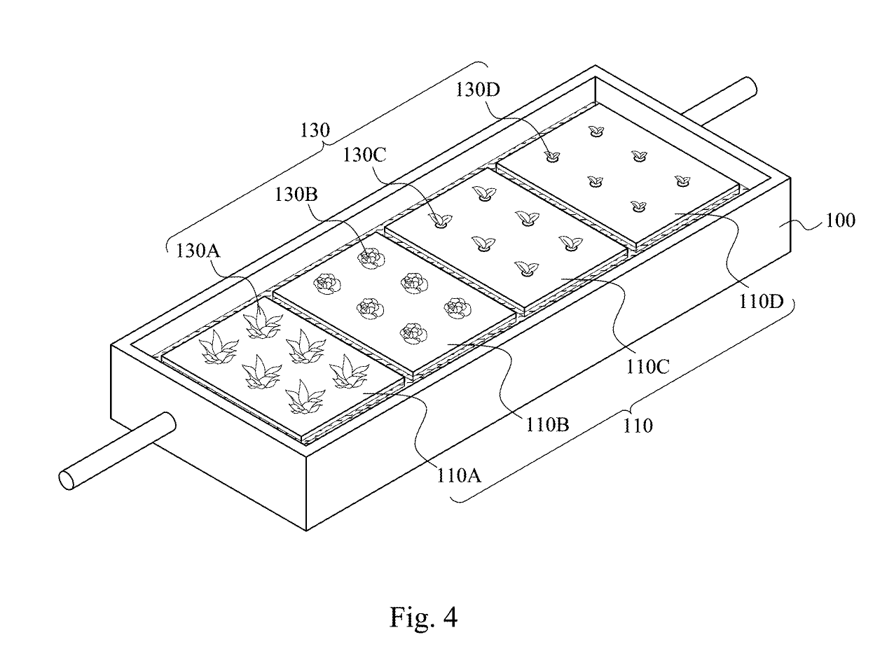

The described cultivating period (or cultivating stages) is merely used to explain, and is not used to limit the present disclosure. Further, the unit of the cultivating period is not limit to day, and may be week or hour in some other embodiments. For example, in FIG. 4, a container 100 includes four cultivating boards 110A to 110D, with hydroponic plants 130A to 130D cultivated thereon, respectively. Similarly, the hydroponic plants 130A to 130D correspond to different cultivating stages. It is noted that the number of the cultivating boards 110 depends on the cultivating stage of the hydroponic plants 130. For example, if the cultivating stage of the hydroponic plants 130 is 7 days, the number of the cultivating boards 110 may be 7. Also, if the cultivating stage of the hydroponic plants 130 is N days (N weeks or N hours), the number of the cultivating boards 110 may be N.

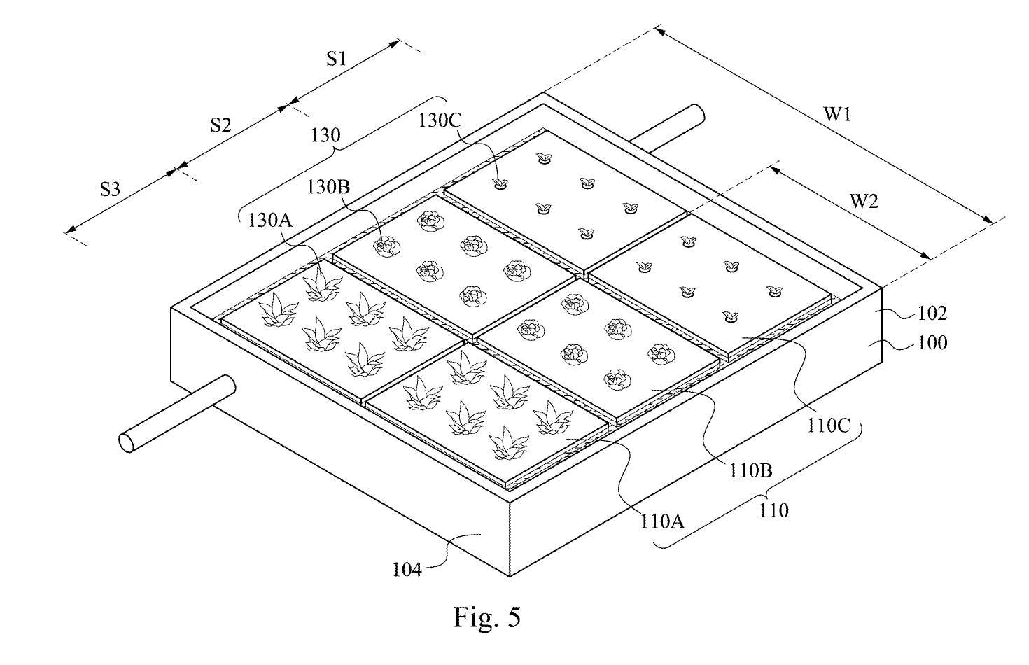

FIG. 5 is a perspective view of hydroponic systems in accordance with some embodiments. In some embodiments, the container 100 has a width W1, and the cultivating boards 110 have a width W2, in which the width W1 is double the width W2. Thus, the container 100 may accommodate two cultivating boards 110 along the width direction. Along the length direction of the container 100, the hydroponic plants 130 is cultivated by periodically moving the cultivating boards 110, as described in FIGS. 1A to 3. In the present embodiment, along the width direction of the container 100, two cultivating boards 110C correspond to the cultivating stage S1, two cultivating boards 110B correspond to the cultivating stage S2, and two cultivating boards 110A correspond to the cultivating stage S3, respectively. Similarly, the cultivating boards 110A to 110C have different hydroponic plants 130A to 130C with different growing phases. Accordingly, during harvest, two cultivating boards 110A may be taken out from the second side 104 of container 100, and dispose two cultivating boards (not shown) into the container 100 from the first side 102 to start a new cultivating cycle.

The container 100 may accommodate more cultivating boards 110 by increasing the width of the container 100. Thus, the yield may be improved, and the system may be operated efficiently with the easy and convenient method of the present disclosure. The number of the cultivating boards 110 depends on the cultivating stages of the cultivating period of the hydroponic plants 130, and also depends on the number of the cultivating boards 110 along the width direction of the container 100. For example, in the present embodiment, the cultivating period of the hydroponic plants 130 is three days, the container 100 includes two cultivating boards 110 along the width direction of the container 100, and the total number of the cultivating boards 110 is 3*2=6. That is, the total number of the cultivating boards 110 in the container 100 is a multiple of the cultivating stages of the hydroponic plants 130. It is noted that the above description is merely used to explain, and is not used to limit the present disclosure. In practice, the actual number of the cultivating boards 110 varies from the cultivating period of the hydroponic plants and the cultivating boards 110 along the width direction of the container 100. For example, if the hydroponic plants has P cultivating stages, and the container 100 includes N cultivating boards 110 along the width direction, the total number of the cultivating boards 110 is P*N.

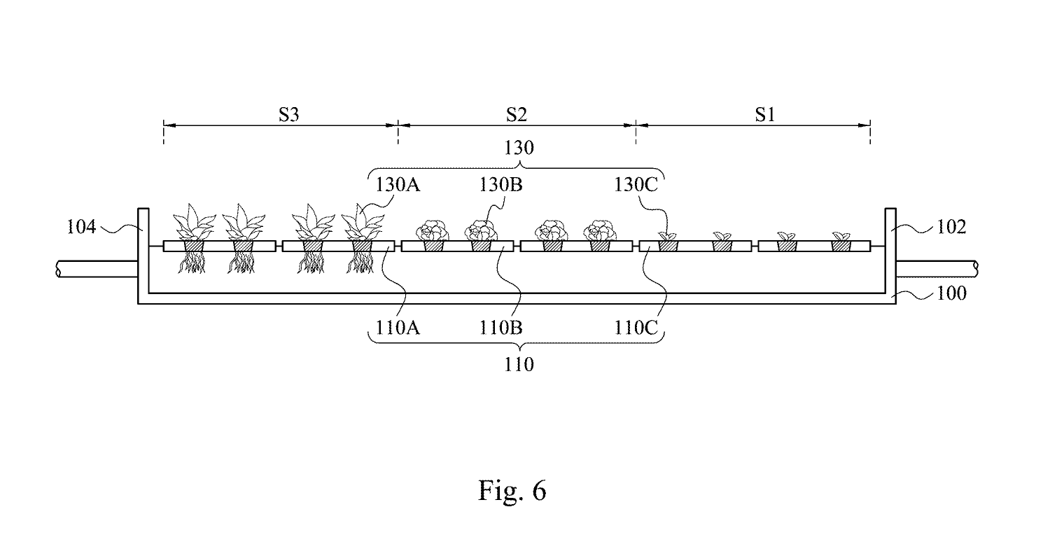

FIG. 6 is a cross-sectional view of a hydroponic system 10 in accordance with some embodiments. FIG. 6 is different from FIG. 5, in that each of the cultivating stages, such as the cultivating stages S1 to S3, includes two cultivating boards 110 disposed therein. That is, along the length direction of the container 100, the cultivating stage Si includes two cultivating boards 110C, the cultivating stage S2 includes two cultivating boards 110B, and the cultivating stage S3 includes two cultivating boards 110A. Accordingly, during harvest, two cultivating boards 110A may be taken out from the second side 104 of container 100, and two new cultivating boards (not shown) are then disposed into the container 100 from the first side 102 of the container 100 to start a new cultivating cycle.

The number of the cultivating boards 110 depends on the cultivating period of the hydroponic plants 130, and also depends on the number of the cultivating boards 110 included in each of the cultivating stages (e.g. the cultivating stages S1 to S3). For example, in the present embodiment, the cultivating period of the hydroponic plants 130 is three days, each of the cultivating stages S1 to S3 includes two cultivating boards 110, and the total number of the cultivating boards 110 is 3*2=6. That is, the total number of the cultivating boards 110 in the container 100 is a multiple of the cultivating stages of the hydroponic plants 130. It is noted that the above description is merely used to explain, and is not used to limit the present disclosure. In practice, the actual number of the cultivating boards 110 varies from the cultivating stages of the hydroponic plants and the cultivating boards 110 included in each of the cultivating stages (e.g. the cultivating stages S1 to S3). For example, if the hydroponic plants has P cultivating stages, and each of the cultivating stages (e.g. the cultivating stages S1 to S3) includes N cultivating boards 110 along the width direction, the total number of the cultivating boards 110 is P*N. With such configuration, the cultivation may be flexible with more cultivating boards having smaller size, which are easier to take out. Also, once the hydroponic plants on the cultivating boards need to be modified, the small cultivating boards may be taken out without disturbing other hydroponic plants on other cultivating boards.

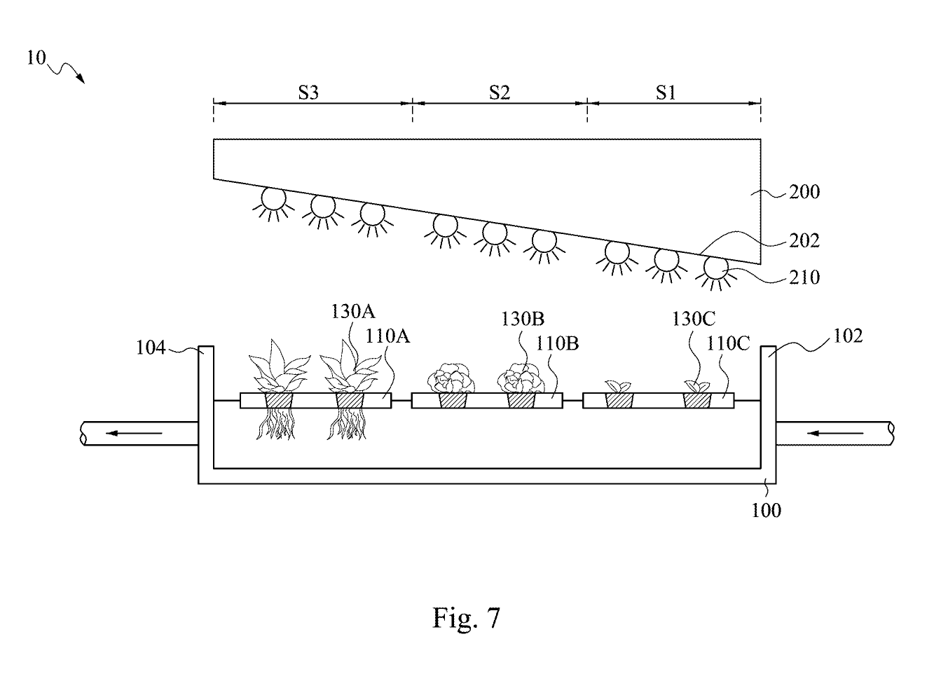

FIG. 7 is a cross-sectional view of a hydroponic system 10 in accordance with some embodiments. The hydroponic system 10 further includes a lighting device 200 having a plurality of lights 210. The lighting device 200 has an inclined surface 202 with respect to the container 100. For example, the inclined surface 202 rises from the first side 102 toward the second side 104 of the container 100. That is, the inclined surface 202 rises from the cultivating boards 110C toward 110A. From other perspectives, the inclined surface 202 rises along the cultivating stage S1 to S3 of the hydroponic plants. In some embodiments, the lighting device 200 may be artificial light source, such as lamp bracket. The lights 210 may be LED, fluorescent tube, and/or T5, T8 tube.

Due to the growth of the hydroponic plants, the hydroponic plants 130C, 130B, and 130A in the cultivating stages S1, S2, and S3, respectively, may have different height. The hydroponic plants 130A in the cultivating stage S3 have largest height for the longest cultivation, and the hydroponic plants 130C in the cultivating stage S1 have lowest height for the shortest cultivation. The lights 210 corresponding to the cultivating stage S1 are positioned at a lower level to provide sufficient light to the hydroponic plants 130C. With such configuration, the surface 202 of the lighting device 200 are designed to have different heights of the lights 210, thereby providing better lighting condition to the hydroponic plants 130.

In some embodiments, the inclination level of the surface 202 depends on the variety and the growth of the hydroponic plants 130. Users can modify the inclination level of the surface 202 to obtain a better cultivation quality according to the actual condition. In some other embodiments, the surface 202 of the lighting device 200 is adjustable, and the users can modify the inclination level of surface 202 during the cultivating period to obtain a best lighting quality.

In detail, since the hydroponic plants in different growing phases need different illuminance to have a desired growing quality. In the present embodiment, a distance between the lighting device and the cultivating boards are modified, such that hydroponic plants in different growing phases may receive desired illuminance. On the other hands, since the hydroponic plants are sensitive to the light, the inclination level of surface 202 is modified to provide sufficient illuminance but without light burn.

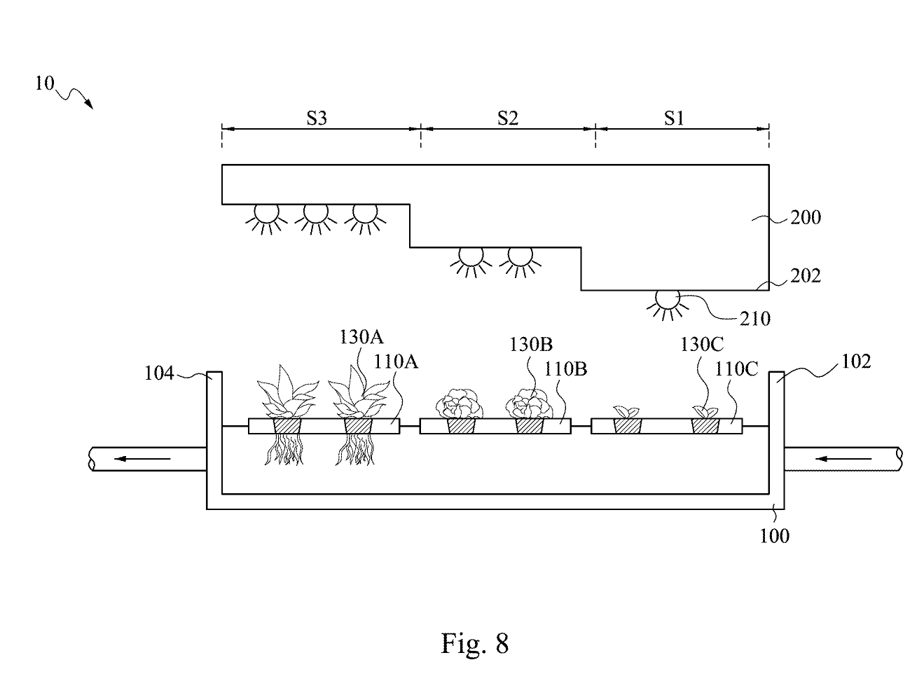

FIG. 8 is a cross-sectional view of a hydroponic system 10 in accordance with some embodiments. FIG. 8 is different from FIG. 7, in that the surface 202 of the lighting device 200 is step-shape, and the lights 210 are disposed on the step-shape surface 202. In the present embodiment, the number of steps is equal to that of the cultivating stages, but the disclosure is not limit thereto. For example, the hydroponic plants 130 have three cultivating stages S1 to S3, and the number of steps is three, accordingly. The step-shape surface 202 rises from the first side 102 toward the second side 104 of the container 100. That is, the step-shape surface 202 rises from the cultivating boards 110C toward 110A. From other perspectives, the step-shape surface 202 rises along the cultivating stage S1 toward S3 of the hydroponic plants.

The lights 210 corresponding to the cultivating stage S1 are positioned at a lower level to provide sufficient light to the hydroponic plants 130C. With such configuration, the surface 202 of the lighting device 200 are designed to have different heights of the lights 210, thereby providing better lighting condition to the hydroponic plants 130.

Since the illuminance on the hydroponic plants depends on the number of the lights and the distance between the hydroponic plants and the lights, the number of the lights 210 may be properly modified. The number of the lights 210 may be modified according to the variety, the growing condition of the hydroponic plants, and the horizontal level of the step-shape surface 202. For example, the hydroponic plants 130C at the cultivating stage S1 have lower height, and thus the step-shape surface 202 is closer to the cultivating board 110C. The number of the lights 210 may be reduced but still provide sufficient illuminance to the hydroponic plants 130C, thereby maintaining good cultivating quality. The reduction of the lights 210 not only provides better illuminance to the hydroponic plants 130C, but also saves power and prevents waste, such as electricity and lighting consumables. It is noted that the number of the lights 210 illustrated in FIG. 8 is merely used to explain, and is not used to limit the present disclosure.

Referring back to FIG. 7, the modification of the number of the lights may also be applied to embodiment in FIG. 7. For example, the lighting device 200 may be divided into three regions, in which the three regions correspond to the cultivating stages S1, S2, and S3. Since the hydroponic plants 130C in stage S1 have lower height, the number of the lights in this region may be properly reduced. In practice, the profile (e.g. inclined or step-shape) of the surface 202 may be modified according to the variety and growing condition of the hydroponic plants, thereby saving the power and still maintaining better cultivating quality.

The present disclosure provides a cultivating board with hydroponic plants cultivated thereon. The cultivating board is disposed in a container filling with a cultivating medium. According to the cultivating stages of the hydroponic plants, the cultivating board is periodically moved from a first side toward a second side of the container to complete a cultivating period. Such system may reduce damage from transplantation, and save labor and times, thereby increasing the cultivating efficiency. Further, the cultivating board floating on the cultivating medium provides not only easy and convenient operation, but also reduces weight and cost.

On the other hands, the present disclosure provides a lighting device disposed over the container. The level of the surface of the lighting device and the number of the lights of the lighting device may be modified according to the variety and growing condition of the hydroponic plants, thereby saving the power and still maintaining better cultivating quality.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A hydroponic system, comprising:
a container having a first side and a second side opposite to the first side;
a cultivating medium filling in the container; and
a plurality of cultivating boards disposed in the container, wherein the cultivating boards comprises a plurality of hydroponic plants cultivated thereon, wherein:
the hydroponic plants of each of the cultivating boards correspond to one of a plurality of cultivating stages of the hydroponic plants; and
the cultivating boards are sequentially arranged from the first side toward the second side, and sequentially arranged along the cultivating stages of the hydroponic plants.

2. The hydroponic system of claim 1, wherein a number of the cultivating boards in the container is a multiple of a number the cultivating stages of the hydroponic plants.

3. The hydroponic system of claim 1, further comprising a supply pipe and a drain pipe disposed on the container.

4. The hydroponic system of claim 3, wherein the supply pipe is disposed on the first side of the container, and the drain pipe is disposed on the second side of the container.

5. The hydroponic system of claim 1, further comprising a plurality of absorbent disposed in the cultivating boards to absorb the cultivating medium.

6. The hydroponic system of claim 1, further comprising:
a lighting device comprising a plurality of lights, wherein a distance between a surface of the lighting device and the cultivating boards rises from the first side of the container toward the second side of the container.

7. The hydroponic system of claim 6, wherein the surface of the lighting device is divided into a plurality of regions, each of the regions respectively corresponds to one of the cultivating stages, and the regions have different number of the lights.

8. A hydroponic system, comprising:
a container having a first side and a second side opposite to the first side;
a plurality of hydroponic plants cultivated in the container, wherein the hydroponic plants have a plurality of cultivating stages, and the container is divided into a plurality of regions along the first side toward the second side according to the cultivating stages, wherein the regions are sequentially arranged along the cultivating stages, and the hydroponic plants in each of the regions correspond to one of the cultivating stages; and
a lighting device comprising a plurality of lights disposed over the container, wherein a distance between a surface of the lighting device and the cultivating boards rises from the first side of the container toward the second side of the container.

9. The hydroponic system of claim 8, wherein the surface of the lighting device is divided into a plurality of regions, each of the regions respectively corresponds to one of the cultivating stages, and the regions comprise different number of the lights.

10. The hydroponic system of claim 8, wherein the surface of the lighting device is an inclined surface.

11. The hydroponic system of claim 8, wherein the surface of the lighting device is a step-shape surface.

12. The hydroponic system of claim 11, wherein the step-shape surface comprises a plurality of steps, and each of the steps corresponds to one of the cultivating stages of the hydroponic plants.

13. A method for operating a hydroponic system, comprising:
disposing a cultivating board having a plurality of hydroponic plants cultivated thereon into a container from a first side of the container, wherein the container is filled with a cultivating medium, the hydroponic plants have a cultivating period having a plurality of cultivating stages;
moving the cultivating board toward a second side of the container along with the cultivating stages of the hydroponic plants; and
taking out the cultivating board from the second side of the container after experiencing the cultivating stages and harvesting the hydroponic plants.

14. The method of claim 13, further comprising:
modifying a first length of the container and a second length of the cultivating board, such that the second length is substantially equal or smaller than the quotient of the first length divided by a number of the cultivating stages.

15. The method of claim 13, wherein the moving the cultivating board is operated by pushing the cultivating board toward a second side of the container.

16. The method of claim 13, further comprising:
disposing a supply pipe on the first side of the container; and
disposing a drain pipe on the second side of the container.

17. The method of claim 13, further comprising:
disposing a lighting device having a plurality of lights over the container; and
modifying a distance between a surface of the lighting device and the cultivating board.

18. The method of claim 17, further comprising:
modifying a number of the lights of the lighting device according to a growing condition of the hydroponic plants.

19. The method of claim 17, further comprising modifying an inclination level of the surface of the lighting device.

20. The method of claim 17, further comprising modifying a profile of the surface of the lighting device.
